(19) United States
(12) Patent Application Publication
(10) Pub. No.: US 2019/0385283 A1
(43) Pub. Date: Dec. 19, 2019

(54) IMAGE PRE-PROCESSING FOR OBJECT RECOGNITION

(71) Applicant: Honeywell International Inc., Morris Plains, NJ (US)

(72) Inventors: Scott McCloskey, Minneapolis, MN (US); Michael Albright, Minneapolis, MN (US); Pedro Davalos, Plymouth, MN (US); Ben Miller, Mountain View, CA (US); Asongu Tambo, Plymouth, MN (US)

(21) Appl. No.: 16/445,162

(22) Filed: Jun. 18, 2019

Related U.S. Application Data
(60) Provisional application No. 62/686,284, filed on Jun. 18, 2018.

(51) Int. Cl. G06T 5/00; G06K 9/00; G06T 7/70

(52) U.S. Cl. CPC G06T 5/003; G06T 7/70; G06K 9/00624

(57) ABSTRACT

The present disclosure relates to devices, systems, and methods of image pre-processing for object recognition. One method includes analyzing data about an image to determine one or more characteristics of the image that indicate whether one or more enhancements should be performed on the data, selecting one or more enhancements to consider applying to the data based on the one or more determined characteristics, analyzing the data to determine whether performing each of the selected enhancements will improve the image quality, determining which one or more enhancements to select to perform on the data based on the analysis of whether performing the selected enhancements will improve the image quality, and performing the selected enhancements on the data to improve the image quality.

### PRIORITY INFORMATION

This application is a Non-Provisional of U.S. Provisional Application No. 62/686,284, filed Jun. 18, 2018, the contents of which are incorporated herein by reference.

### TECHNICAL FIELD

The present disclosure relates to devices, systems, and methods of image pre-processing for object recognition.

### BACKGROUND

Recognizing objects in an image or video is important in a number of commercial domains. For example, such functionality can be beneficial in fields of technology including security (e.g., detecting people and/or vehicles), autonomous or assisted navigation (e.g., recognizing roadways, parking spaces, obstacles), retail (e.g., recognizing a size, type, shape of a packaged good), and/or connected workers (e.g., recognizing parts of a larger device).

Object recognition algorithms have improved greatly in the last several years due to the emergence of deep learning, but their performance is still limited by the quality of the input image. Input images may be too blurry, hazy, or otherwise degraded by the capture scenario.

Additionally, camera-related degradation may arise from the use of interlacing, high compression, or rolling-shutter mechanisms. Such mechanisms can, independently or in combination, degrade the image when mechanisms combine to distort the original image data in a non-beneficial manner.

### BRIEF DESCRIPTION OF THE DRAWINGS

FIG. 1 illustrates an example of a flow diagram for determining which enhancements to make on an image consistent with an embodiment of the present disclosure.

FIG. 2 illustrates an example of a flow diagram for determining whether to deinterlace an image consistent with an embodiment of the present disclosure.

FIG. 3 illustrates an example of a flow diagram for determining whether to enhance an image in one or two ways consistent with an embodiment of the present disclosure.

FIG. 4 illustrates an example of a flow diagram for determining whether to deinterlace an image or implement a different type of enhancement consistent with an embodiment of the present disclosure.

FIG. 5 illustrates an example of a flow diagram for determining the type of image to be enhanced the type of enhancement to be implemented consistent with an embodiment of the present disclosure.

FIG. 6 illustrates an example of a flow diagram for determining the type of image to be enhanced the type of enhancement to be implemented consistent with an embodiment of the present disclosure.

FIGS. 7-10 illustrates an example of a deinterlace enhancement technique to be implemented consistent with an embodiment of the present disclosure.

FIG. 11 illustrates a computing system for use in a number of embodiments of the present disclosure.

FIG. 12 illustrates an example of a deinterlacing enhancement that can be accomplished according to an embodiment of the present disclosure.

FIG. 13 illustrates an example of an Artifact Reduction enhancement that can be accomplished according to an embodiment of the present disclosure.

### DETAILED DESCRIPTION

The present disclosure relates to devices, systems, and methods of image pre-processing for object recognition. One method includes analyzing data about an image to determine one or more characteristics of the image that indicate whether one or more enhancements should be performed on the data, selecting one or more enhancements to consider applying to the data based on the one or more determined characteristics, analyzing the data to determine whether performing each of the selected enhancements will improve the image quality, determining which one or more enhancements to select to perform on the data based on the analysis of whether performing the selected enhancements will improve the image quality, and performing the selected enhancements on the data to improve the image quality.

Different kinds of uses/analyses of the enhanced images, downstream from the image enhancement step, may warrant different kinds of image enhancements. For instance, if enhanced images are consumed by human analysts (e.g. intelligence analysts) for manual visual inspection, one set of enhancements (such as artifact reduction) that improve aesthetic quality could be very beneficial. But for other kinds of downstream analysis, like automated object detection or automated object classification (which are performed by algorithms), visual aesthetics are less important, but other enhancements could be more beneficial, e.g. image enhancements that strengthen the low-level image features that are used by said algorithms to perform image classification. (Enhancement of these image features can improve the performance of object classification algorithms but may degrade the aesthetic quality of the image and hence degrade the image's interpretability to human analysts.) So the sensitivity of the particular downstream application to different kinds of defects may warrant different kinds of image enhancements.

While there have been methods and algorithms proposed to address *individual* types of image degradation, including those listed above, the prior art is generally lacking in methods that analyze imagery and apply only those processing methods which are needed to improve the specific combination of issues related to a particular image. Absent this capability, the naive approach of applying all processing methods will generally worsen the performance of downstream object recognition.

By selecting only those methods which are necessary, the embodiments of the present disclosure reduce this unintended drawback. The technical advantage of having higher performance object recognition can translate into different business advantages based on the field of technology.

In the security realm, for instance, improving object detection performance would reduce the need to deploy a security guard for a false positive, and increase the effectiveness of a system as true detections are increased. In the retail space, being able to recognize objects more easily would increase productivity by reducing the need to re-image an object in order to positively identify it. The embodiments of the present disclosure can be beneficial to process imagery and video. These embodiments can be used on still and video imagery to enhance the quality, and reverse various degradations, in order to improve the performance of downstream object recognition utilizing the imagery.

Embodiments of the present disclosure, for example, include an analysis module that assesses an image to determine which, if any, of one or more image processing methods should be applied in order to improve the image recognition performance. The analysis module may consider, among other factors:
The source camera type (e.g., which may be provided in metadata, or file name of the saved image).
The output of a detector trained to determine the presence of a certain type of imaging artifact.
The setting of the image (i.e., indoor vs. outdoor classification).
The specific type of downstream analysis to be applied. Certain processing methods may be better suited to downstream analysis by automated methods, while others may be better suited to eventual human inspection.

Optionally, one way to determine whether a particular method will be beneficial is to apply the method and analyze statistics of the downstream object recognition results.

A separate component of an approach provided herein, which can occur after the analysis module determines the type of enhancement method to apply, is to evaluate the quality of the image. If the quality is found to be sufficient, then the original image is preserved, whereas if the quality is found to be insufficient, then the corresponding enhancement method is applied. Evaluating the quality can be achieved by using quality detection algorithms, such as blur detection, a Brisque-type algorithm for scoring quality, or other suitable quality detection algorithm.

In some embodiments, multiple image enhancement steps can be applied—one chained after the other—based on input from the analysis module. For example, interlacing artifacts could be removed, if present, then compression artifacts and other defects can be removed from the intermediate image, before a final enhanced image is produced.

In the detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

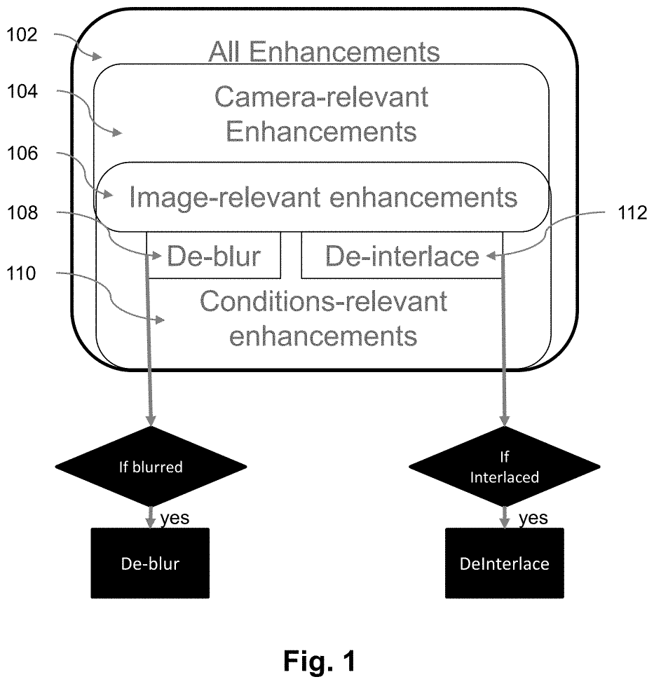

FIG. 1 illustrates an example of a flow diagram for determining which enhancements to make on an image consistent with an embodiment of the present disclosure. FIG. 1 illustrates a general premise approach that can be taken in some embodiments, where the largest area of the diagram 102 includes all enhancements that could possibly be made to an image.

From this large group, multiple criteria can be used to select one or more enhancements from the broader group. In this example, the multiple criteria include: camera relevant enhancements 104, conditions relevant enhancements 110, and image relevant enhancements 106.

Camera relevant enhancements can, for example, be enhancements that are characteristics of certain cameras. For example, a particular type of camera can be prone to blur and, therefore, if that camera type is identified, then de-blurring can be an enhancement available to potentially be implemented. The converse can be true in that, if a camera is known not to exhibit an image quality problem (e.g., interlacing), that enhancement technique can be removed from the possible enhancement choices that can be made. Such information can be provided, for example, from a database.

Conditions relevant enhancements can, for example, be enhancements that are characteristics of certain conditions of the image. For example, if a camera is at a long range, haze can be an issue, where at short range, haze is not an issue and so enhancements to improve an image that has haze effects can be eliminated from consideration for short range images (e.g., images on the surface of the Earth versus those at high altitude that are considered long range).

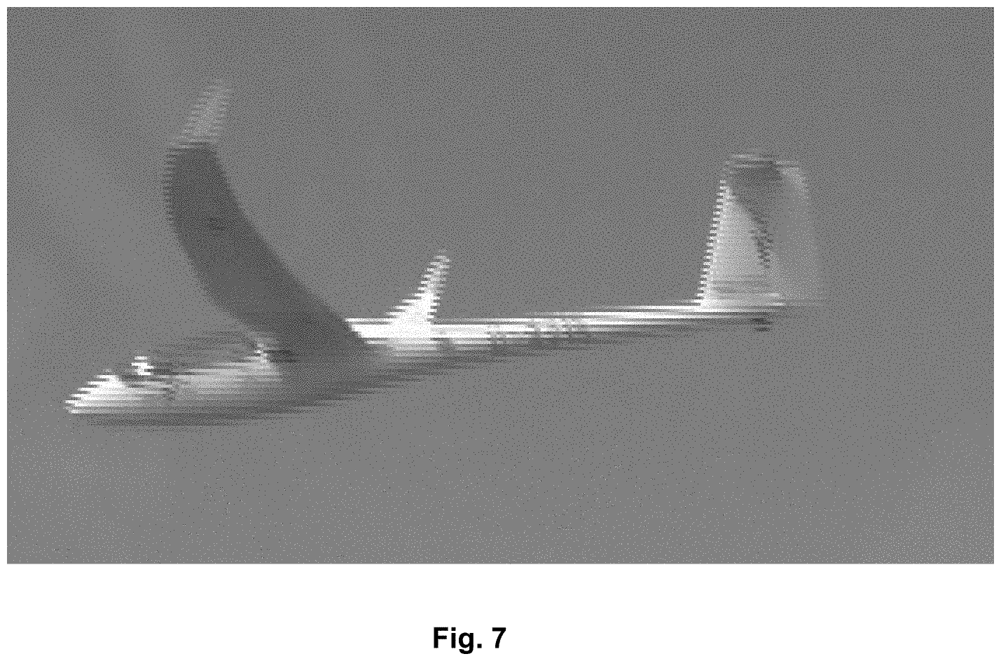

Image relevant enhancements can be identified based on examination of the image itself. For example, interlacing can be identified based on an analysis technique discussed with respect to FIGS. 7-10 below. Such image relevant enhancements can be identified as necessary based on testing of the image data or based on a quality scale, such as the Blind/Referenceless Image Spatial Quality Evaluator (BRISQUE). In cases where a quality scale is used, a threshold system can be employed to determine which enhancements should be implemented. For example, if a quality scale value does not meet a first threshold value, then a first enhancement should be implemented because the threshold value is indicative that a certain image quality issue is present.

In some embodiments, multiple enhancements can be implemented if the quality scale value is below a second threshold value. In such embodiments, a first enhancement could be applied and the image reevaluated to see if it has improved beyond a second threshold at which value is indicative that a second enhancement may be appropriate.

For example, a first threshold may indicate that interlacing may be occurring and once that is remedied or reduced, the quality value may indicate that a condition, such as blur, may be present. Once the deblur enhancement is implemented, the image can be reevaluated to determine it is of a desired quality.

Based on an evaluation process as discussed with respect to FIG. 1, the number of possible enhancement techniques can be limited to only those that are most relevant to the particular image being adjusted and, therefore, application of unnecessary enhancements can be avoided. This can particularly be true if the unnecessary enhancements are not made available to the system implementing the enhancements or to a user as an option, if enhancements are being manually implemented.

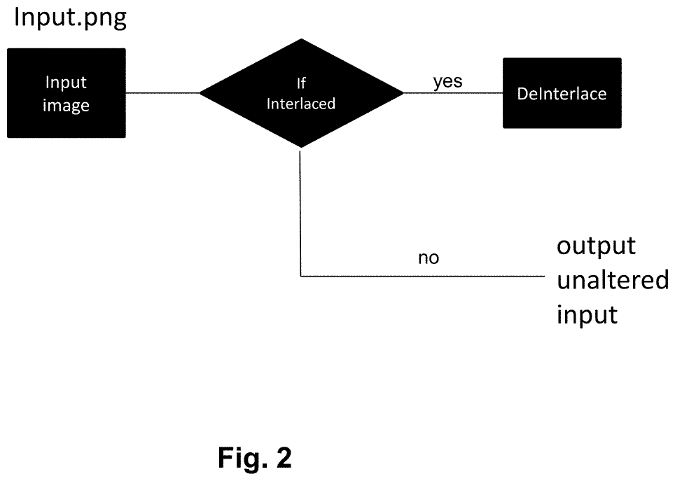

FIG. 2 illustrates an example of a flow diagram for determining whether to deinterlace an image consistent with an embodiment of the present disclosure. In FIG. 2, an analysis algorithm is shown wherein only one criterion is evaluated. In this embodiment, the system is only looking at whether interlacing is present. This evaluation can be accomplished as shown in the example presented in FIGS. 7-10 below.

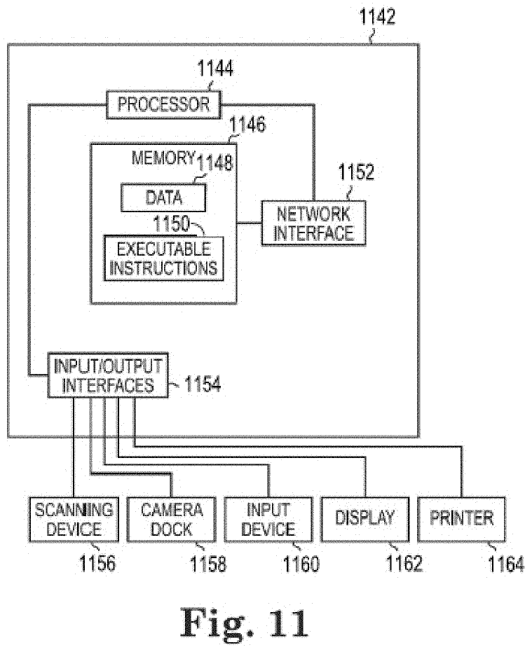

In the example of FIG. 2, the image (input.png) is received by the image enhancement system (executable instructions stored in memory and executed by a processor on a computing device, such as that shown in FIG. 11) and an evaluation of whether the image is exhibiting interlacing. Any suitable interlacing detection algorithm can be utilized to identify if the image is exhibiting interlacing.

If it is not, then the unaltered input image is output from the system. If interlacing is determined to be present in the image, then a deinterlacing enhancement operation is implemented and the enhanced image is output.

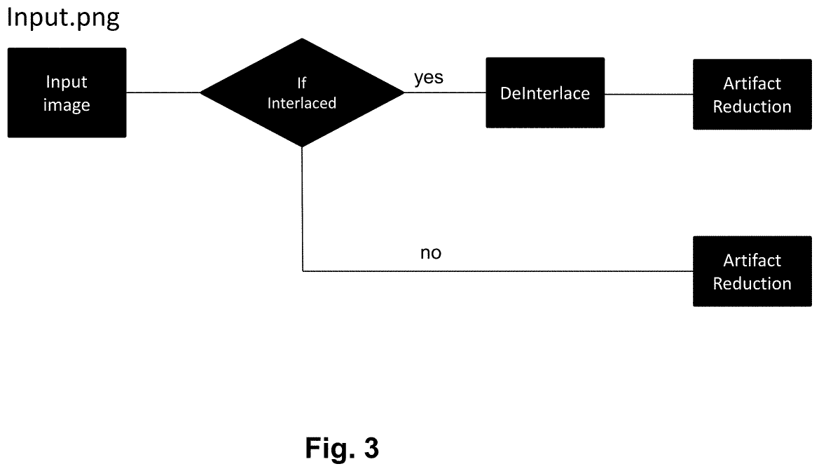

FIG. 3 illustrates an example of a flow diagram for determining whether to enhance an image in one or two ways consistent with an embodiment of the present disclosure. In this example, it has been determined by the system that, in this case, an artifact reduction enhancement will be implemented. This determination, for example, can be made based on identification of a camera type or a condition in which such an enhancement will be beneficial in all or nearly all cases. For example, an image taken at ground level may be likely to benefit from artifact reduction, whereas long range images would have a low likelihood of benefiting from such an enhancement and, therefore, artifact reduction would not be suggested or implemented.

In the embodiment shown in FIG. 3, an interlacing evaluation is initiated and, if interlacing is found to be present in the image, a deinterlacing operation is initiated. Regardless of whether interlacing is present, an artifact reduction enhancement is also implemented. In some embodiments, the system can also predetermine which enhancement is accomplished first.

For example, in this implementation, the deinterlacing process happens first because the artifacts to be removed during the artifact reduction process will be more evident once the interlacing has been reduced or eliminated by the deinterlacing process. Such preferences of order of enhancement can be programmed into the executable instructions by the software programmer.

This preference hierarchy of enhancement can then be beneficial as an order of manual enhancements can be predetermined for a user that may not understand which enhancement to apply and/or in what order. In an automated system, such instructions can apply multiple enhancements in an order that can result in the best overall enhancement of the image.

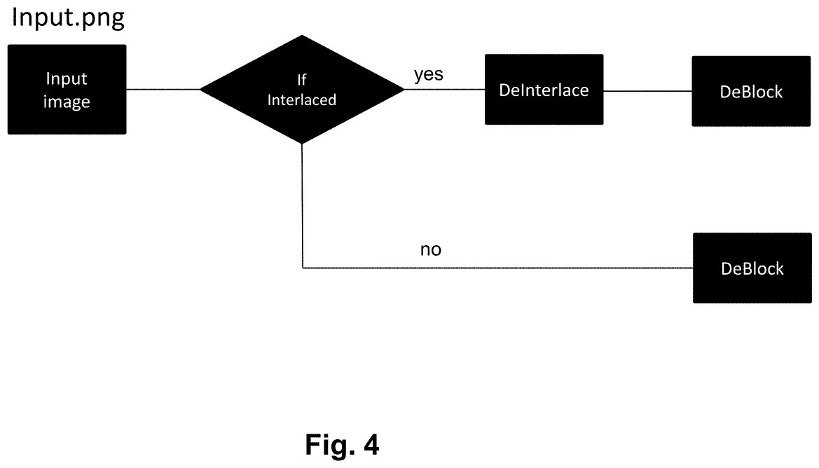

FIG. 4 illustrates an example of a flow diagram for determining whether to deinterlace an image or implement a different type of enhancement consistent with an embodiment of the present disclosure. FIG. 4 is similar to the embodiment of FIG. 3, but with the difference being that a deblocking enhancement is applied regardless of whether interlacing is present in the image.

Such a decision to apply an enhancement regardless of the outcome of another enhancement evaluation can be determined based on the camera type and/or condition that the image was taken. These criteria can be identified, for example, be reading metadata attached to the image data which indicates the camera type or condition in which the image was taken. This information could also be provided to the system by a user, via a user interface.

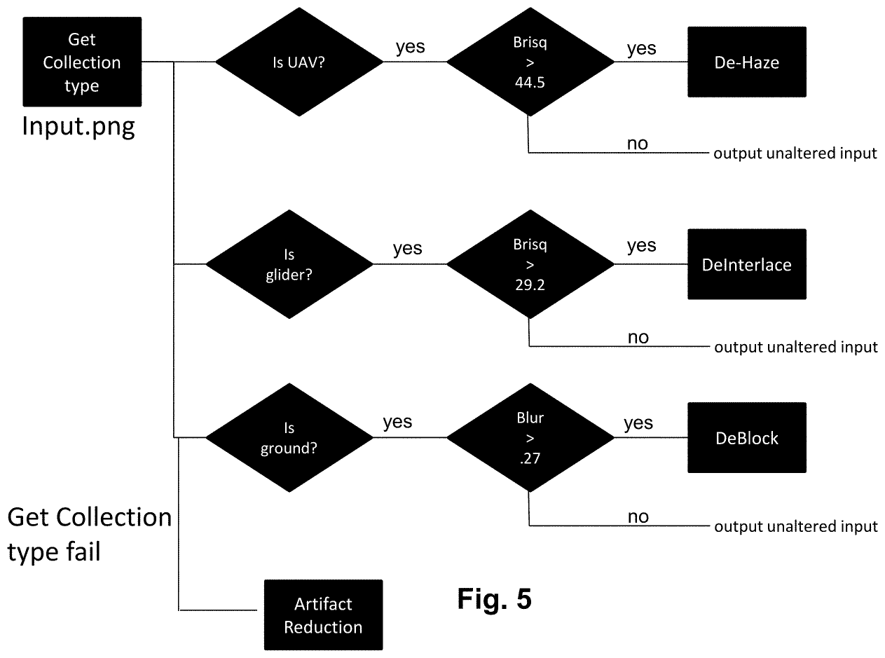

FIG. 5 illustrates an example of a flow diagram for determining the type of image to be enhanced the type of enhancement to be implemented consistent with an embodiment of the present disclosure. FIG. 5 shows an embodiment where the system evaluates multiple criteria in determining what enhancement techniques to apply to the image.

In this example, the system receives the image including information about the type of collection used to capture the image (e.g., camera type and/or one or more conditions image was captured). Using the information provided, the system determines in which condition the image was taken. The conditions illustrated here are long range (an imaging device on an unmanned aerial vehicle (UAV)), medium range (glider), and short range (an imaging device on the ground). Based on the condition, the types of enhancements to be utilized will be limited to those that will be useful to the enhancement of those types of images. In this example, if the image is long range, then a dehaze enhancement is selected, if the image is medium range, then a deinterlace enhancement is selected, and if the image is short range a deblock enhancement is selected. This embodiment also includes a feature in which if no condition can be determined, a default enhancement process (artifact reduction) can be implemented.

Additionally, as can be seen from this example, the quality scale or type of quality scale (e.g., BRISQUE or Blur) used can be different for different types of images and, therefore, the system can be programmed to change the scale values used based on the criteria of the camera or conditions to evaluate the quality of the image. Shown in FIG. 5 are thresholds for a BRISQUE scale wherein, if a quality score of an image is above a threshold value (e.g., greater than 44.5 for a long range image), then a dehaze enhancement process should be implemented. In this manner, the system can be tailored to the camera and/or conditions present for each particular image to be evaluated.

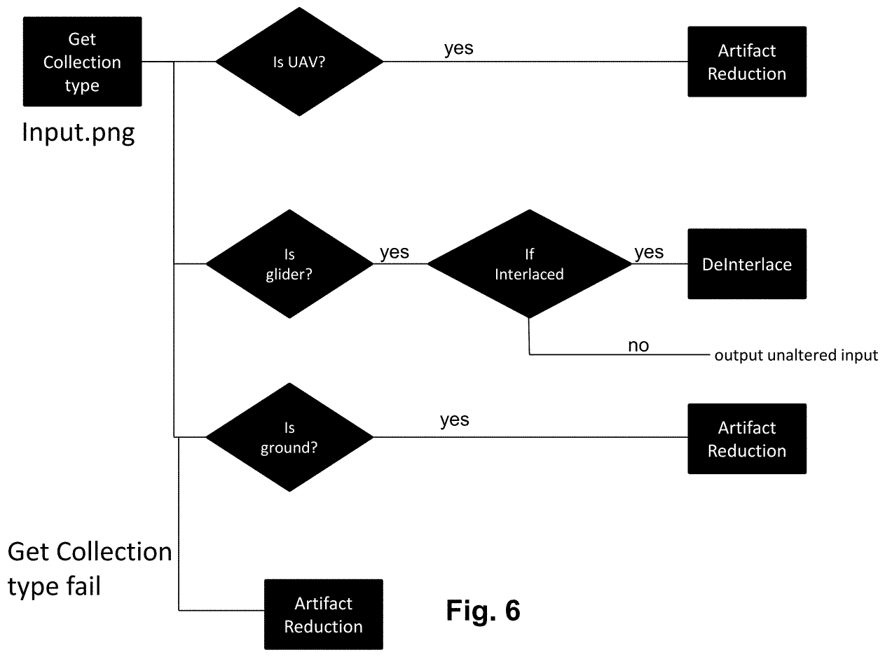

FIG. 6 illustrates an example of a flow diagram for determining the type of image to be enhanced the type of enhancement to be implemented consistent with an embodiment of the present disclosure. Similarly to the embodiment of FIG. 5, the collection information can be used to determine the process of enhancement.

However, here, the collection information is used to determine which enhancement is to be implemented. In this example, if the image is long range, then an artifact reduction technique should be employed, if the image is medium range, then testing for interlacing should be performed, and if the image is short range, then artifact reduction should be performed. Alternatively, if no condition can be identified, then artifact reduction should be performed. In such embodiments, the system can be adapted based on criteria known about when the image was taken which can be beneficial as the enhancement techniques chosen based on those one or more criteria can drastically change the quality of the resultant output image.

FIGS. 7-10 illustrate an example of a deinterlace enhancement technique to be implemented consistent with an embodiment of the present disclosure. FIG. 7 shows an image exhibiting interlacing in which portions of the image are staggered with respect to other portions. Such a problem can be identified based on analysis of the image data as will be discussed in more detail below.

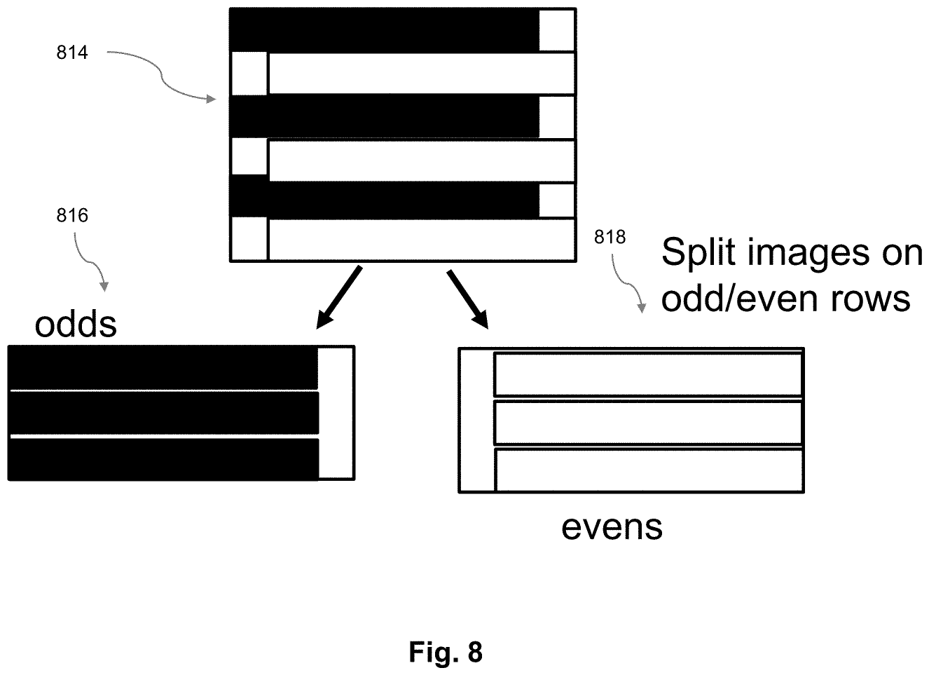

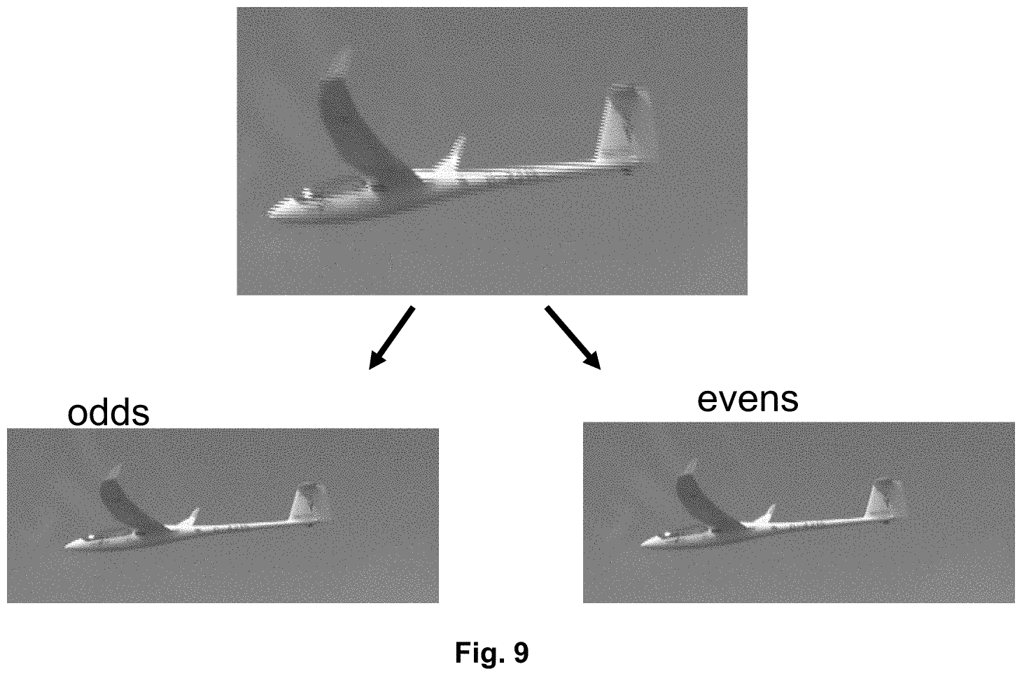

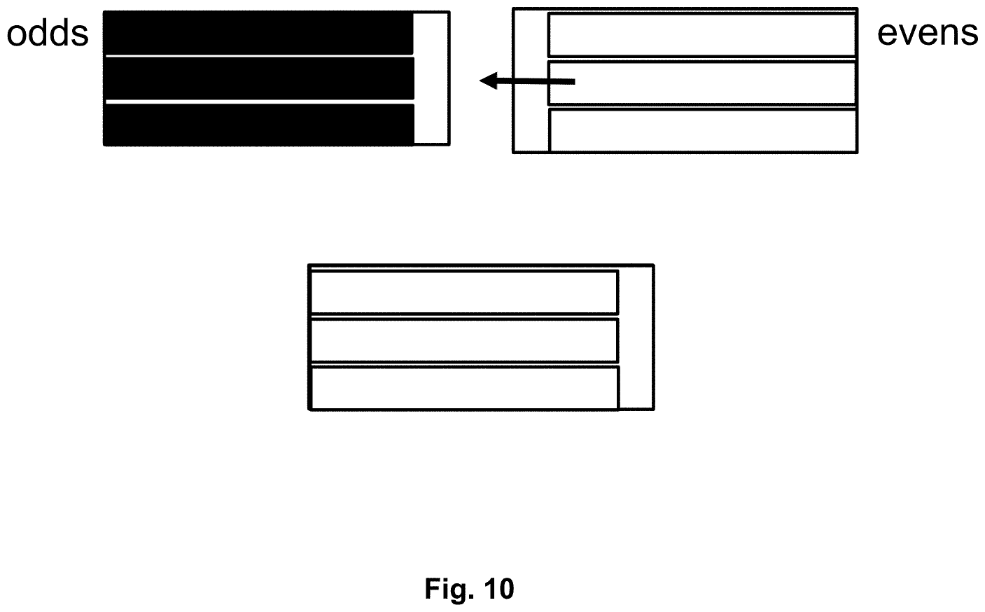

In FIG. 8, the image is split into even and odd pixel rows. These pixel rows can be merged together into images of just even and just odd images, as shown in FIG. 9. These images are then compared (upper images in FIG. 10) and a translation vector computed that aligns the two images so that they correlate with each other (lower image in FIG. 10), as shown in FIG. 10. If the vector's x-component (where x and y coordinates are used) exceeds a threshold, then it indicates that the image is interlaced. Accordingly, this technique is also herein used to determine whether interlacing is present.

If interlacing is detected in the image, the image is deinterlaced to remove the interlacing defect. One way to do so is to (1) start with the original image with the interlacing defect, (2) retain the odd rows but discard the even rows of the original image, and (3) compute new values for even rows by linearly interpolating between odd rows, then substitute those new even rows into the image. This produces an enhanced image with the interlacing defect removed.

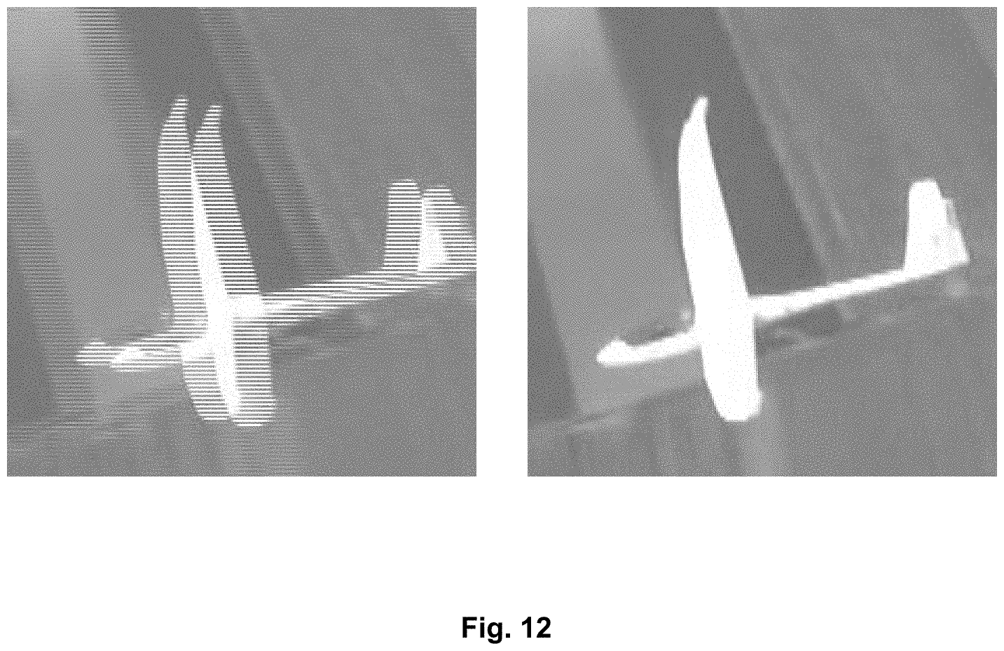

FIG. 12 shows the original image with interlacing defect (left) and the enhanced image with the interlacing defect removed (right)

Such a process can be used to enhance an image, but when used when not necessary or in the wrong order with other enhancements, it may reduce the quality of the output image. The embodiments of the present disclosure can reduce or eliminate such issues by using criteria to determine which enhancement techniques to use and when to use them.

The embodiments of the present disclosure can be provided on or executed by a computing device. An example of a computing device is provided below in FIG. 11.

FIG. 11 illustrates a computing system for use in a number of embodiments of the present disclosure. For instance, a computing device 1142 can have a number of components coupled thereto.

The computing device 1142 can include a processor 1144 and a memory 1146. The memory 1146 can have various types of information including data 1148 and executable instructions 1150, as discussed herein.

The processor 1144 can execute instructions 1150 that are stored on an internal or external non-transitory computer device readable medium (CRM). A non-transitory CRM, as used herein, can include volatile and/or non-volatile memory.

Volatile memory can include memory that depends upon power to store information, such as various types of dynamic random access memory (DRAM), among others. Non-volatile memory can include memory that does not depend upon power to store information.

Memory 1146 and/or the processor 1144 may be located on the computing device 1142 or off of the computing device 1142, in some embodiments. As such, as illustrated in the embodiment of FIG. 11, the computing device 1142 can include a network interface 1152. Such an interface 1152 can allow for processing on another networked computing device, can be used to obtain information about the image (e.g., characteristics of the image, enhancement preferences for a particular image type, etc.) and/or can be used to obtain data and/or executable instructions for use with various embodiments provided herein.

As illustrated in the embodiment of FIG. 11, the computing device 1142 can include one or more input and/or output interfaces 1154. Such interfaces 1154 can be used to connect the computing device 1142 with one or more input and/or output devices 1156, 1158, 1140, 1142, 1164.

For example, in the embodiment illustrated in FIG. 11, the input and/or output devices can include a scanning device 1156, a camera dock 1158, an input device 1140 (e.g., a mouse, a keyboard, etc.), a display device 1142 (e.g., a monitor), a printer 1164, and/or one or more other input devices. The input/output interfaces 1154 can receive executable instructions and/or data, storable in the data storage device (e.g., memory), representing an image (i.e., static image or video image) to be enhanced.

In some embodiments, the scanning device 1156 can be configured to scan one or more images to be enhanced. In some embodiments, the camera dock 1158 can receive an input from an imaging device such as a digital camera, a printed photograph scanner, and/or other suitable imaging device. The input from the imaging device can, for example, be stored in memory 1146.

Such connectivity can allow for the input and/or output of data and/or instructions among other types of information. Some embodiments may be distributed among various computing devices within one or more networks, and such systems as illustrated in FIG. 11 can be beneficial in allowing for the capture, calculation, and/or analysis of information discussed herein.

The processor 1144, can be in communication with the data storage device (e.g., memory 1146), which has the data 1148 stored therein. The processor 1144, in association with the memory 1146, can store and/or utilize data 1148 and/or execute instructions 1150 for identifying imaging device type, image type, image format type, image perspective, determine type of enhancements available, determine the enhancements to be used, and/or implement the image enhancement.

Provided below are examples of before and after images showing the benefits of a couple of enhancement techniques that can be used in the embodiments of the present disclosure. FIG. 12 illustrates an example of a deinterlacing enhancement that can be accomplished according to an embodiment of the present disclosure. As discussed with respect to FIGS. 7-10, the deinterlacing technique can have dramatic impact on the output image by using a vector adjustment to rows of pixels within the input image. In the example shown in FIG. 12, the image on the left shows an image that is exhibiting an interlacing image quality problem. Through use of a deinterlacing technique, such as that discussed herein, the image on the right side can be obtained.

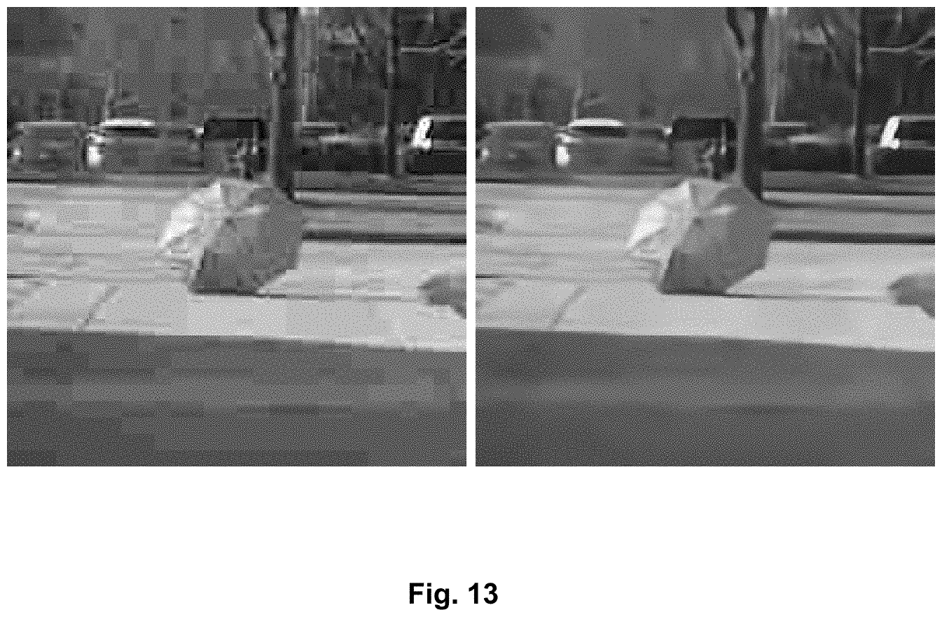

FIG. 13 illustrates an example of an Artifact Reduction enhancement that can be accomplished according to an embodiment of the present disclosure. Artifact Reduction is a technique used to minimize artifacts evident in an image. Particularly, lossy compression introduces complex compression artifacts, particularly blocking artifacts, ringing effects, and blurring. In the example of FIG. 13, an artifact reduction technique is utilized on the image on the left to render the resultant image on the right. As can be seen in this example, blocking artifacts, ringing, and blurring have been reduced.

Through selective use of this and other enhancement techniques, as implemented by the embodiments of the present disclosure, the embodiments can provide improved output images as compared to prior implementations of enhancement techniques. These improvements are the result of making the determinations based on camera and condition information to limit or select that enhancements to be used and/or the order in which the enhancements are to be implemented.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A method of image pre-processing for object recognition, comprising:
analyzing data about an image to determine one or more characteristics of the image that indicate whether one or more enhancements should be performed on the data;
selecting one or more enhancements to consider applying to the image based on the one or more determined characteristics;
analyzing the data to determine whether performing each of the selected enhancements will improve the image quality;
determining which one or more enhancements to select to perform on the image based on the analysis of whether performing the selected enhancements will improve the image quality; and
performing the selected enhancements to improve the image quality.

2. The method of claim 1, further comprising, wherein analyzing data about an image to determine one or more characteristics of the image that indicate whether one or more enhancements should be performed on the data includes analyzing the content of the image to determine the sensor type.

3. The method of claim 1, further comprising, wherein analyzing data about an image to determine one or more characteristics of the image that indicate whether one or more enhancements should be performed on the data includes analyzing metadata within an image data file to determine a camera type.

4. The method of claim 1, further comprising, wherein analyzing data about an image to determine one or more characteristics of the image that indicate whether one or more enhancements should be performed on the data includes analyzing metadata within an image data file to determine environmental conditions in which the image was captured.

5. The method of claim 1, further comprising, wherein analyzing data about an image to determine one or more characteristics of the image that indicate whether one or more enhancements should be performed on the data includes analyzing metadata within an image data file to determine a setting of the image.

6. The method of claim 1, further comprising, wherein analyzing data about an image to determine one or more characteristics of the image that indicate whether one or more enhancements should be performed on the data includes analyzing the sensitivities of downstream analysis to be applied.

7. The method of claim 1, further comprising, performing object recognition on the data to identify an item within the image after enhancements are performed.

8. A device for image pre-processing for object recognition, comprising:
a processor; and
memory having instructions executable by the processor to:
analyze data used to display an image to determine one or more characteristics of the image that indicate whether one or more enhancements should be performed on the data;
select one or more enhancements to consider applying to the data based on the one or more determined characteristics;
analyze the data to determine whether performing each of the selected enhancements will improve the image quality;
determine which one or more enhancements to select to perform on the data based on the analysis of whether performing the selected enhancements will improve the image quality; and
perform the selected enhancements on the data to improve the image quality.

9. The device of claim 8, wherein the one or more enhancements are selected from a number of camera relevant enhancements.

10. The device of claim 8, wherein the one or more enhancements are selected from a number of conditions relevant enhancements.

11. The device of claim 8, wherein the one or more enhancements are selected from a number of image relevant enhancements.

12. A non-transitory computer readable medium having computer readable instructions stored thereon that are executable by a processor to:
analyze data used to display an image to determine one or more characteristics of the image that indicate whether one or more enhancements should be performed on the data;
select one or more enhancements to consider applying to the data based on the one or more determined characteristics;
analyze the data to determine whether performing each of the selected enhancements will improve the image quality;
determine which one or more enhancements to select to perform on the data based on the analysis of whether performing the selected enhancements will improve the image quality; and
perform the selected enhancements on the data to improve the image quality.

13. The medium of claim 12, wherein the medium includes instructions to select multiple enhancements to perform on the data.

14. The medium of claim 12, wherein the medium includes instructions to determine an order by which the enhancements are performed.

15. The medium of claim 13, wherein the medium includes instructions to perform the selected enhancements on the data to improve the image quality in the determined order.

16. The medium of claim 13, wherein the instruction to analyze data used to display an image to determine one or more characteristics of the image that indicate whether one or more enhancements should be performed on the data includes analyzing metadata within an image data file to determine a whether the image is a short range, medium range, or long range image.

17. The medium of claim 13, wherein the instruction to analyze data used to display an image to determine one or more characteristics of the image that indicate whether one or more enhancements should be performed on the data includes instructions to determine whether the image may be subject to one or more of haze, blurring, interlacing, and an imaging artifact.

18. The medium of claim 13, wherein the instruction to analyze the data to determine whether performing each of the selected enhancements will improve the image quality includes instructions to analyze whether the data meets a first quality threshold after a first enhancement is performed.

19. The medium of claim 18, wherein the instruction to analyze the data to determine whether performing each of the selected enhancements will improve the image quality includes instructions to analyze whether the data meets a second quality threshold after a second enhancement is performed.

20. The medium of claim 18, wherein the instruction to analyze the data to determine whether performing each of the selected enhancements will improve the image quality includes instructions to analyze whether the data meets a second quality threshold after a second enhancement is performed and wherein the second quality threshold is a higher threshold than the first quality threshold.
